(19) United States
(12) Patent Application Publication
(10) Pub. No.: US 2013/0214188 A1
(43) Pub. Date: Aug. 22, 2013

(54) ADJUSTABLE STROKE ACTUATORS

(71) Applicant: Terry Glenn Young, Longview, TX (US)

(72) Inventor: Terry Glenn Young, Longview, TX (US)

(73) Assignee: ARRAY HOLDINGS, INC., Houston, TX (US)

(21) Appl. No.: 13/774,399

(22) Filed: Feb. 22, 2013

Related U.S. Application Data
(60) Provisional application No. 61/602,001, filed on Feb. 22, 2012.

(51) Int. Cl. F16K 31/44

(52) U.S. Cl. CPC F16K 31/44
USPC 251/285

(57) ABSTRACT

A valve actuator apparatus and method for adjusting for valve bore drift using an adjustable downstop is disclosed. The adjustable downstop comprises a downstop and a drift adjuster. The drift adjuster can me moved in an upwards or downwards direction to increase or decrease the stroke length of the operator shaft.

### PRIORITY

This application claims priority to U.S. Provisional Application 61/602,001, filed on Feb. 22, 2012, the contents of which are specifically incorporated herein.

### FIELD

The present invention relates generally to valve actuators. More particularly the present invention relates to a valve actuator having improved adjustment ability in order to compensate for valve drift.

### BACKGROUND

A valve is a device that regulates the flow of a substance. Valves are produced in a variety of different styles, shapes and sizes. Typically, valves are used for gases and liquids. However, valves are also used on solids capable of flow, slurries or any other substance capable of flow. Valves are used in almost every industry having a substance that flows.

Gate valves are generally comprised of a valve body having a central axis aligned with inlet and outlet passages, and a space between the inlet and outlet passages in which a slide, or gate, may be moved perpendicular to the central axis to open and close the valve. In the closed position, the gate surfaces typically seal against sealing rings which surround the fluid passage through the valve body. Gate valves have been used for centuries to control the flow of a great variety of fluids. Often the fluid to be controlled by the gate valve is under pressure. In the petroleum industry, gate valves are used along piping at various locations, and in particular are used in piping referred to in the petroleum industry as a Christmas tree, which is used as part of a drilling operation.

A gate valve opens by moving a blocking element from the path of flow. The blocking element may be a round disk, a rectangular element, or a wedge. Gate valves have a blocking element and a seat forming a substantially leak proof seal. In a gate valve, the blocking element can be referred to as a gate valve block, a gate block or a block. In the open position, a gate valve has a bore where the substance is allowed to partially or completely flow through the valve. In a gate valve, the bore may be referred to a gate valve bore. When the gate valve bore is across the valve bore the gate valve is in an open position. When the gate valve block is across the valve bore, the gate valve is in a closed position.

Gate valves may be operated manually or automatically. One method to automatically operate a gate valve is to use an actuator. An actuator is a mechanical device for moving or controlling a mechanism or system. When an actuator is used in a gate valve, the actuator is typically linked to a stem to repeatedly move the valve gate between open and closed positions.

Actuators to open and close the gate valves may include manual operators, diaphragm-type operators, pneumatic operators and hydraulic operators. Often, a manual operator is combined with a manual operator with a diaphragm-type, pneumatic or hydraulic operator for back-up and test purposes. Additionally, the actuator may include a bonnet assembly, which interconnects the valve body and the valve gate, and a bonnet stem which is movable with the gate via an operator.

Actuators to open and close the gate valves may include manual operators, diaphragm-type operators, and hydraulic operators. The actuator may include a bonnet assembly, which interconnects the valve body and the valve gate, and a bonnet stem which is movable with the gate via an operator. The operator typically has a maximum force capability for applying to the bonnet stem. It is sometimes desirable to provide additional opening/closing power on a temporary basis without having to remove the original operator. It is also desirable that the same operator be adaptable to various control accessories, such as a mechanical override, hydraulic override, heat sensitive lock open device, block open cap, electrical limit switch and/or other electrical accessories.

In some cases, it would be desirable, to adjust the drift of the actuator without removing the bonnet assembly. This may prove difficult in implementation however, because changes in the actuator may require changes in upstop and downstop adjustments in order to ensure that the gate is positioned correctly when open and when closed. Additionally, drift shims have been traditionally employed to help adjust drift. However, the use of drift shims may require additional disassembly of the actuator for the installation.

While movement of the actuator housing against the bonnet may provide some advantages in correcting for valve drift, it may be desirable to have some actuator adjustment, such as spring compression and tension adjustment or other adjustments which modify the stroke of the actuator and ensure that the gate valve attached to the actuator opens and closes optimally.

### SUMMARY

Certain embodiments of the invention pertain to an actuator for moving a valve gate between open and closed valve positions within a valve body. In such embodiments the actuator may comprise: an actuator housing have a proximal end oriented toward a gate valve and a distal end oriented away from the gate valve, the proximal end of the actuator housing surrounding an adjustment plate; the adjustment plate further having a proximal side oriented toward the gate valve and a distal side oriented toward the actuator; the adjustment plate further having an internal bore centered within the adjustment plate.

Still further, the actuator may comprise an operator shaft with a distal end and a proximal end, the proximal end extending through a bore of a bonnet into the valve body, the operator shaft further defining a shaft axis.

Likewise in this embodiment, the actuator may possess a piston having a distal side oriented toward a pressure chamber and a proximal side operatively connected to a spring adjusting nut, the spring adjusting nut further having an inward facing wall slidably abutting a distal end of downstop having a distal end and a proximal end;

Still further, it is contemplated that the actuator may be adjusted via an adjuster plug having a proximal end and a distal end, the plug being further positioned substantially within the center of the adjustment plate; the distal end of the plug being slidably connected to an adjuster ring capable of being moved in a proximal or distal direction; the adjuster ring having a distal end oriented toward the proximal end of the downstop;

In such embodiments, the distal end of the adjuster ring and the proximal end of the downstop define a stroke distance; wherein movement of the adjuster ring in a proximal or distal direction increases or decreases the stroke distance of the actuator upon pressurization of the pressure chamber.

Further, in embodiments of the invention, wherein the downstop further comprises an inward facing wall, the distal end of the operator shaft may be operatively connected to the distal end of the downstop.

In embodiments of the invention concerning the adjuster plug, the adjuster plug may have an internal bore wherein proximal end of the operator shaft extends through the internal bore of the adjuster plug, exits the proximal end of the adjuster plug and enters a distal end of a packing retainer also having a proximal end and an outward facing wall.

Still further, in the aforementioned embodiment, the bonnet may have an internal bore with an inward facing wall, wherein the proximal end of the packing retainer is situated within the internal bore of the bonnet and wherein the outward facing wall of the packing retainer abuts the inward facing wall of the internal bore of the bonnet.

In embodiment of the invention, the actuator may further comprise a spring having an outer diameter, the spring being capable of producing a biasing force opposing axial movement of the operator shaft toward the valve body.

Further embodiments concern a cylinder and the piston, wherein the housing comprises a cylinder with an inward facing wall and an outward facing wall; the outward facing wall oriented toward an inward facing wall of the housing and wherein the piston has an outward facing wall that slidably abuts the inward facing wall of the piston. In such embodiments, the housing may be unpressurized and the spring, operator shaft, outward facing wall of the cylinder and downstop are enclosed in an unpressurized housing.

In many embodiments of the invention, the actuator has a top shaft. The proximal end of the top shaft may be in physical connection with the distal side of the piston.

Regarding the downstop, in certain embodiments the downstop may be capable of movement in a proximal or distal direction relative to the spring adjustment nut. Also, the stroke of the actuator may be further adjusted by movement of the downstop in a proximal or distal direction.

The actuator may further comprise a bonnet adjuster having an outward facing wall and an inward facing wall, the inward facing wall adapted to receive the proximal end of the adjustment plug and the distal end of the packing retainer. In such embodiments, the bonnet adjuster may operatively connect the adjustment plug to the bonnet. Further, regarding the bonnet adjuster, the bonnet may be slidably connected to the inward facing wall of the bonnet adjuster. Likewise, the adjustment plug may be slidably connected to the inward facing wall of the bonnet adjuster. In such embodiments movement of the bonnet in a proximal or distal direction in relation to the bonnet adjuster increases or decreases a travel distance of the operator shaft through the adjustment plug. Likewise movement of the adjustment plug in a proximal or distal direction in relation to the bonnet adjuster increases or decreases a travel distance of the operator shaft through the adjustment plug.

Regarding further movement of the operator shaft, movement of the downstop in a proximal or distal direction, movement of the adjuster ring in a proximal or distal direction, or a combination thereof may result in adjusting the stroke of the actuator without increasing or decreasing tension of the central spring.

It is contemplated in this invention that the actuator may move the operator shaft by pneumatic or hydraulic pressure acting upon the pressure chamber of the actuator.

Further embodiments of the invention contemplate that the adjustment plate possesses an internal bore wherein the adjuster plug may be positioned substantially within the internal bore of the adjustment plate. Alternatively the adjustment plate and the adjuster plug and the adjuster plate may be a unitary component.

### BRIEF DESCRIPTION OF THE DRAWINGS

FIG. 1 is a cross sectional illustration of the adjustable actuator.

FIG. 2 is a cross sectional illustration of the adjuster plug.

FIG. 3 is an alternate embodiment of a cross sectional illustration of the adjuster plug.

### LIST OF REFERENCE NUMERALS

10 actuator housing

20 cylinder

30 interior bore

40 top shaft

50 top plug

60 pressure relief ports

70 burst discs

80 top shaft retainer plate

90 top shaft piston

100 polypack seals

110 spring adjusting nut

120 downstop

130 spring guide cylinder

140 spring guide cylinder flange

150 upper spring retainer ring

160 lower spring retainer ring

170 central spring

180 adjustment plate

190 adjustment plug

195 external portion of the adjustment plug

200 anti-rotation keys

210 adjuster ring

215 adjuster ring bolts

220 drift adjusters

230 bonnet adjuster

235 distal adjuster bolts

237 proximal adjuster bolts

240 bonnet

245 horizontal bores

250 packing retainer

270 operator shaft

280 seals

300 adjuster ring internal threading

310 adjustment plug external threading

320 adjustment plug ware bearings

400 unified adjustment plug and adjustment plate

### DETAILED DESCRIPTION

Introduction

The embodiments of the invention relate to actuators. While an exemplary embodiment of the invention relates to hydraulic or pneumatic actuators, a method to adjust drift and spring tension within an actuator is intended to encompass piston and diaphragm actuators as well. The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings making apparent to those skilled in the art how the several forms of the invention may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{th} Edition.

As used herein, the term “pipe” means and refers to a fluid flow path.

As used herein, the term “conduit” means and refers to a fluid flow path.

As used herein, the term “line” means and refers to a fluid flow path.

As used herein, the term “fluid” refers to a non-solid material such as a gas, a liquid or a colloidal suspension capable of being transported through a pipe, line or conduit. Examples of fluids include by way of non-limiting examples the following: natural gas, propane, butane, gasoline, crude oil, mud, water, nitrogen, sulfuric acid and the like.

As used herein, the term “attached,” or any conjugation thereof describes and refers to the at least partial connection of two items.

As used herein, the term “proximal” refers to a direction toward the center of the ball valve.

As used herein, the term “distal” refers to a direction away from the center of the ball valve.

As used herein, slidably connected referrers to one component abutting another component wherein one component is capable of moving in a proximal or distal direction relative to the other component.

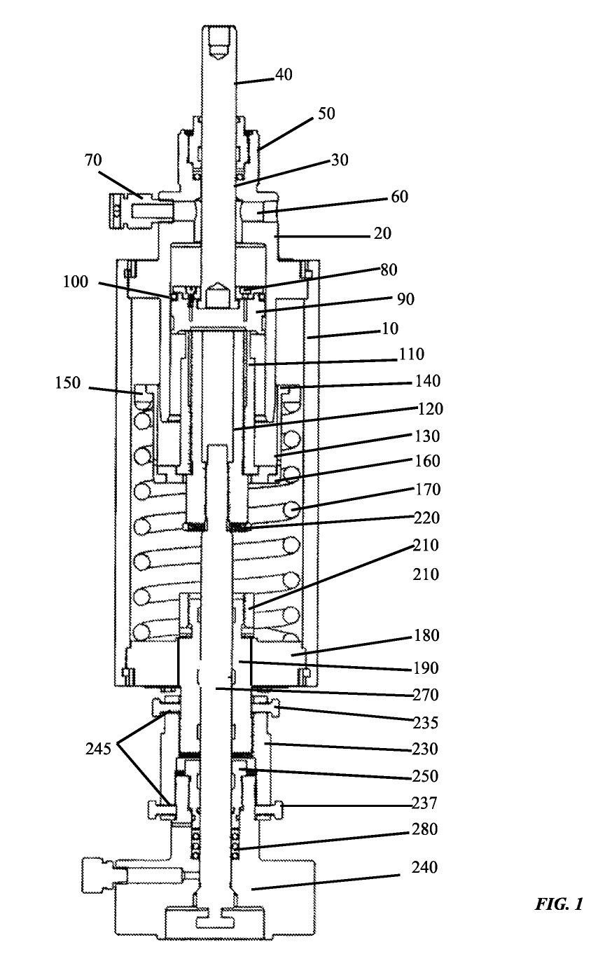

Referring now to the drawings, and more particularly to FIG. 1, a cross sectional illustration of the adjustable actuator is depicted. In the various embodiments, the actuator has a substantially cylindrical actuator housing 1 with a distal end away from a valve attachment site and a proximal end toward a valve attachment site. Affixed to the distal end of the housing is a cylinder 20 which fits within interior circumference of the housing. The cylinder acts as a top plate for the actuator. Still further, the embodiments contemplate that the cylinder has an interior bore 30 through which a top shaft 40 is inserted. The distal end of the cylinder functions as a top plug 50 wherein the top shaft exits the actuator housing.

In certain embodiments, the top shaft is preferably threaded. Still further, immediately proximal to the top shaft, and distal to the housing may be pressure relief ports 60 and optionally one or more burst discs 70.

In certain embodiments, proximal to the burst disc or discs, is an internal cylinder bore which houses the proximal end of the top shaft. In certain embodiments of the invention, the proximal end of the top shaft is flanged and is retained within the actuator by a top shaft retainer plate 80 distal to the flange and a wear bearing 9 proximal to the flange. In certain embodiments, the retainer plate 80 is screwed into the wear bearing 9. Still further in certain embodiments, immediately distal to the wear bearing and in connection with the cylinder are polypack seals 100.

Internal to the cylinder and proximal to the wear bearing is a spring adjusting nut 110. The spring adjusting nut 110 has a hollow bore which is typically threaded. Internal to the hollow bore and with corresponding external threading is a downstop 120. The downstop 120 itself possesses an internal threaded bore into which the operator shaft is threaded. In certain embodiments, between the housing and the cylinder is a spring guide cylinder 130.

The spring guide cylinder 130 has a distal end with a spring guide cylinder flange 140. Surrounding a portion of the spring guide cylinder flange 140, is an upper spring retainer ring 150.

Downward or proximal movement of the spring guide cylinder 130 and downstop 120 is due to hydraulic or pneumatic pressure from the top shaft piston 90 which in turn forces a downward or proximal movement of the spring guide cylinder 130 and downstop 120 through downward or proximal pressure upon the lower spring retainer ring 160. This in turn pulls the spring guide cylinder 130 and upper spring retainer ring 160 in a downward direction, causing compression of the central spring 170.

As indicated above, immediately proximal to the upper spring retainer ring 150 is the central spring 170. The central spring extends from its distal end which is in communication with the upper spring retainer ring 150 to its proximal end which is in communication with an adjustment plate 180 located at the proximal end of the housing.

In certain embodiments of the invention, the adjustment plate 18 has an internal bore containing an adjustment plug 190 and anti-rotation keys 200. In embodiments wherein the adjustment plug is contemplated, the adjustment plug may also possess an internal bore through which the operator shaft 270 runs.

In embodiments of the invention, the distal end of the adjustment plug rises distally to the adjustment plate. The external portion of the adjustment plug 195 is threaded outwardly and adapted to receive an adjuster ring 210 with an internally threaded connection. The adjuster ring can be raised or lowered by turning clockwise or counterclockwise to adjust the actuator relative to the valve. Likewise, proximal to, and attached to the proximal end of the spring downstop are drift adjusters 220 which can further change the distance between the adjustment plug and the downstop 120. Although in many embodiments the use of spring adjustment nut 110 and the adjuster ring 210 may alleviate the need for drift adjusters 220 as the stroke of the actuator may be easily set by these aforementioned features.

It is to be readily understood that in some embodiments, the inward side of the adjuster ring 210 may be smooth instead of threaded and adapted to receive the outward facing external portion of the adjustment plug 195 which is also smooth. In such embodiments, the adjuster ring 210 may possess substantially horizontal bores adapted to receive bolts, screws or pins which would interact with the external portion of the adjustment plug.

Still further, the distance that the operator shaft 270 may move in either a proximal or distal direction may be adjusted externally via the use of the bonnet adjuster 230.

The bonnet adjuster 230 operatively connects the adjustment plug 190 to the bonnet 240. Typically the bonnet adjuster 230, at its distal end possesses an inward facing wall which is threaded and adapted to receive the proximal end of the adjustment plug 190. The proximal end of the adjustment plug is correspondingly threaded on its outwardly facing wall. In this embodiment, rotation of the adjustment plug 190 in relation to the bonnet adjuster 230 moves the actuator in a proximal or distal direction, thereby adjusting the distance the operator shaft 270 may move in a proximal or distal direction. In other embodiments, the outward facing wall of the proximal end of the adjustment plug 190 is smooth and received by a smooth inward facing wall of the distal end of the bonnet adjuster 230. In this embodiment, the adjustment plug 190 is able to slide in a proximal or distal direction with respect to the bonnet adjuster 230.

In certain embodiments, a bonnet adjuster 230 operatively secures the adjustment plug 190 from movement via substantially horizontal bores 245 in the bonnet adjuster 230. These bores are adapted to receive distal adjuster bolts 235 which prevent rotation or movement in the proximal or distal direction by tightening the distal adjuster bolts against the adjustment plug 190. In alternative embodiments, the substantially horizontal bores are adapted to receive pins or screws to achieve the same function.

Still further, as depicted in FIG. 1, the bonnet adjuster 230 has a proximal end with an inward facing wall which is threaded and adapted to receive an outward facing wall of the distal end of the bonnet 240 which is also threaded. Like the aforementioned securing mechanism of the bonnet adjuster 230 to the adjustment plug, substantially horizontal bolts may be adapted to receive proximal adjuster bolts 237 to prevent rotation and thus prevent movement of the actuator in a proximal or distal direction, thereby adjusting the distance the operator shaft 270 may move in a proximal or distal direction.

In other embodiments, the bonnet adjuster 230 has a proximal end with an inward facing wall which is smooth and adapted to receive an outward facing wall of the distal end of the bonnet 240 which is also threaded. In this embodiment, the bonnet adjuster 230 may be secured to the bonnet is able to slide in a distal or proximal direction and is secured from unwanted movement by bonnet adjuster distal bolts 235.

In certain embodiments, the bonnet 240 has an internal bore adapted to receive a packing retainer 250. Typically the packing retainer 250 has an outward facing wall with external threading. Likewise the bonnet has an inward facing wall with internal threading adapted to receive the packing retainer. Typically, as depicted in FIG. 1, the packing retainer 250 has an internal bore adapted to receive the operator shaft. Further the operator shaft 270 runs distally from the bonnet 240, which has an internal bore adapted to receive the operator shaft, through the packing retainer 250, through the adjustment plug 190, which also has an internal bore adapted to receive the operator shaft 270. The operator shaft 270 is depicted in FIG. 1 as being connected at its distal end by being threaded into the proximal end of the downstop 120.

Proximal to the aforementioned packing retainer 250, and sealing the packing retainer 250 from any fluids traveling in a distal direction from the gate valve and the internal bore of the bonnet 240 is a series of seals 280 such as polypack seals. However, it is contemplated that in certain embodiments other seals may be used such as O-ring seals, U-shaped seals and the like. Distal to the proximal end of the packing retainer are a plurality of O-rings as depicted in FIG. 1. The O-rings in FIG. 1 are external to the packing retainer 250 and facing the bonnet 240. Additionally O-rings are present in the internal bore of the packing retainer to further seal fluids from the operator shaft from entering the actuator through the packing retainer 250.

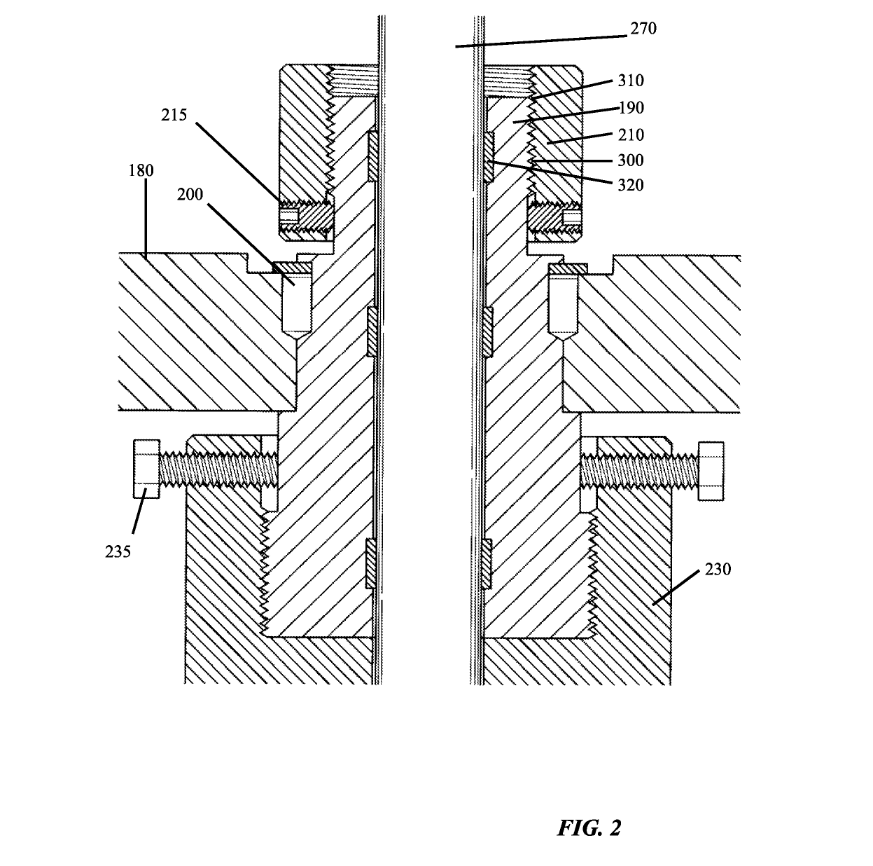

FIG. 2 is a cross sectional illustration of the adjuster plug. As can be seen in FIG. 2, at the top end or distal end of the illustration, the adjuster ring 210 is threaded onto the external portion of the adjustment plug 195 via the interaction between the adjuster ring internal threading 300 and the adjustment plug external threading 310. To secure the adjuster ring 210 to the external portion of the adjustment plug 195 are adjuster ring bolts 215 which are depicted as being substantially longitudinal or horizontal in a perpendicular axis to the proximal to distal axis of the operator shaft 270. As can be seen within the adjustment plug's 190 internal bore are adjustment plug ware bearings 320 which abut and may at least partially surround the operator shaft 270. In preferred embodiments, the adjustment plug ware bearings 320 surround the operator shaft. Proximal to the adjuster ring 210 is the adjustment plate 180 which is perpendicular to the access of the operator shaft 270 and is in physical connection with the adjustment plug 190. To secure the adjustment plug 190 to the adjustment plate 180 are anti-rotation keys 200 which run from a distal to proximal direction at the intersection between the adjustment plug 190 and the adjustment plate 180.

Further, as depicted in FIG. 2, proximal to the adjustment plate 180, the proximal end of the adjustment plug 190 has an outwardly facing threaded wall adapted to be received by inwardly facing threaded wall on the bonnet adjuster 230. In this illustration, rotation of the actuator, an in particular the adjustment plug 190 with respect to the bonnet adjuster 230 is inhibited by at least one distal adjuster bolt 235 traveling through a substantially horizontal bore of the bonnet adjuster 230 to make contact with the adjustment plug.

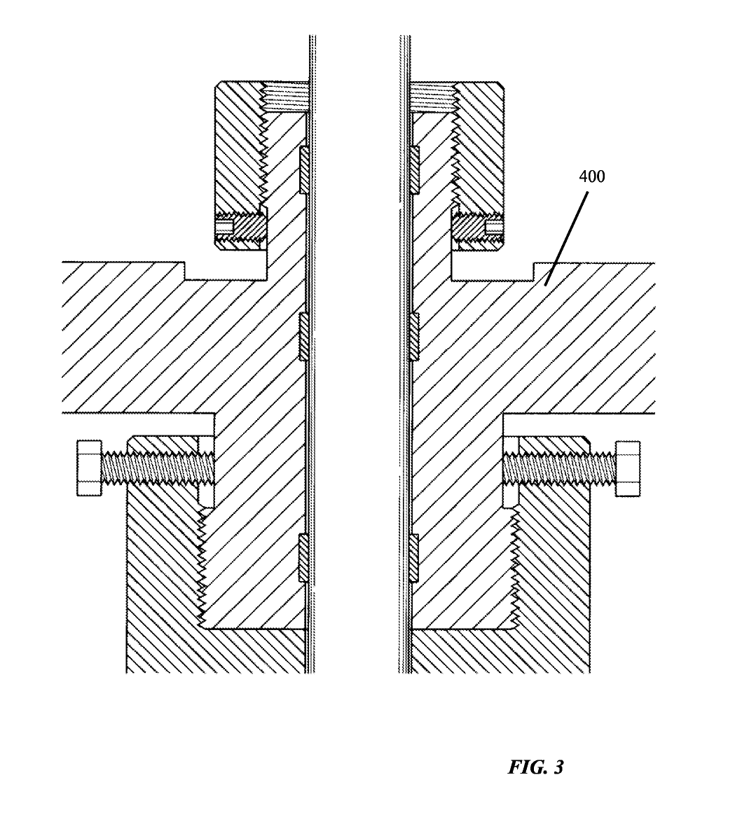

FIG. 3 an alternate embodiment of a cross sectional illustration of the adjuster plug. More specifically, in FIG. 3, anti-rotation keys 200 are not needed to prevent the rotation of a separate adjustment plate 180 and adjustment plug 190. As can be viewed from the illustration, this embodiment has a unified adjustment plug and adjustment plate 400.

In implementation, a user may adjust the stoke of the actuator by removing the actuator housing 100 from the actuator and rotating the downstop 120 in relation to the spring adjusting nut 110. The rotation of the downstop 120 moves the downstop in a proximal or distal direction. Further, the user may adjust the stroke of the actuator by rotating the adjuster ring 210 to move the adjuster ring 210 in a proximal or distal direction with respect to the adjustment plug 190. Upon adjusting either or both the downstop 120 and the adjuster ring 210, the stroke of the actuator, or the distance between the proximal end of the downstop 120 and the distal end of the aduster ring 210 may be increased or decreased. Upon achieving the desired distance, the adjuster ring 21 may be tightened against the adjustment plug 190 via the use of adjuster ring bolts 215.

Further in implementation, the bonnet adjuster 230 can be rotated with respect to the adjustment plug 190 to increase or decrease the ability of the operator shaft 270 to move in a proximal or distal direction by increasing or decreasing the distance from the actuator to the bonnet 240. Upon achieving the desired distance, the bonnet adjuster may be tightened against the adjustment plug 190 via distal adjuster bolts 235. Likewise, the bonnet adjuster 230 can be rotated with respect to the bonnet 240 to increase or decrease the ability of the operator shaft 270 to move in a proximal or distal direction by increasing or decreasing the distance from the actuator to the bonnet 240. Upon achieving the desired distance, the bonnet adjuster 230 may be tightened against the bonnet 240 via proximal adjuster bolts.

The foregoing detailed disclosure and description of the invention is illustrative and explanatory thereof, and it will be appreciated by those skilled in the art, that various changes in the size, shape and materials as well as in the details of the illustrated construction, reliability configurations, or combination of features of the various valve actuator elements of the present invention may be made without departing from the spirit of the invention.

1. An actuator for moving a valve gate between open and closed valve positions within a valve body, the actuator comprising:
a. an actuator housing have a proximal end oriented toward a gate valve and a distal end oriented away from the gate valve, the proximal end of the actuator housing surrounding an adjustment plate; the adjustment plate further having a proximal side oriented toward the gate valve and a distal side oriented toward the actuator; the adjustment plate further having an internal bore centered within the adjustment plate;
b. an operator shaft with a distal end and a proximal end, the proximal end extending through a bore of a bonnet into the valve body, the operator shaft further defining a shaft axis;
c. a piston having a distal side oriented toward a pressure chamber and a proximal side operatively connected to a spring adjusting nut, the spring adjusting nut further having an inward facing wall slidably abutting a distal end of downstop having a distal end and a proximal end;
d. an adjuster plug having a proximal end and a distal end, the plug being further positioned substantially within the center of the adjustment plate; the distal end of the plug being slidably connected to an adjuster ring capable of being moved in a proximal or distal direction; the adjuster ring having a distal end oriented toward the proximal end of the downstop;
wherein the distal end of the adjuster ring and the proximal end of the downstop define a stroke distance; and wherein movement of the adjuster ring in a proximal or distal direction increases or decreases the stroke distance of the actuator upon pressurization of the pressure chamber.

2. The actuator of claim 1, wherein the downstop further comprises an inward facing wall, and wherein the distal end of the operator shaft is operatively connected to the distal end of the downstop.

3. The actuator of claim 2, wherein the adjuster plug has an internal bore, and wherein proximal end of the operator shaft extends through the internal bore of the adjuster plug, exits the proximal end of the adjuster plug and enters a distal end of a packing retainer also having a proximal end and an outward facing wall.

4. The actuator of claim 2, wherein the bonnet has an internal bore with an inward facing wall, wherein the proximal end of the packing retainer is situated within the internal bore of the bonnet and wherein the outward facing wall of the packing retainer abuts the inward facing wall of the internal bore of the bonnet.

5. The actuator of claim 1, further comprising a spring having an outer diameter, the spring being capable of producing a biasing force opposing axial movement of the operator shaft toward the valve body.

6. The actuator of claim 5, wherein the housing comprises a cylinder with an inward facing wall and an outward facing wall; the outward facing wall oriented toward an inward facing wall of the housing and wherein the piston has an outward facing wall that slidably abuts the inward facing wall of the piston.

7. The actuator of claim 6, wherein the housing is unpressurized and the spring, operator shaft, outward facing wall of the cylinder and downstop are enclosed in an unpressurized housing.

8. The actuator of claim 1, further comprising a top shaft having a distal end and a proximal end, the proximal end in physical connection with the distal side of the piston.

9. The actuator of claim 6, wherein the downstop is capable of movement in a proximal or distal direction relative to the spring adjustment nut.

10. The actuator of claim 9, wherein the stroke of the actuator is further adjusted by movement of the downstop in a proximal or distal direction.

11. The actuator of claim 9, further comprising a bonnet adjuster having an outward facing wall and an inward facing wall, the inward facing wall adapted to receive the proximal end of the adjustment plug and the distal end of the packing retainer.

12. The actuator of claim 11, wherein the bonnet adjuster operatively connects the adjustment plug to the bonnet.

13. The actuator of claim 12, wherein the bonnet is slidably connected to the inward facing wall of the bonnet adjuster.

14. The actuator of claim 12, wherein the adjustment plug is slidably connected to the inward facing wall of the bonnet adjuster.

15. The actuator of claim 13, wherein movement of the bonnet in a proximal or distal direction in relation to the bonnet adjuster increases or decreases a travel distance of the operator shaft through the adjustment plug.

16. The actuator of claim 14, wherein movement of the adjustment plug in a proximal or distal direction in relation to the bonnet adjuster increases or decreases a travel distance of the operator shaft through the adjustment plug.

17. The actuator of claim 6, wherein movement of the downstop in a proximal or distal direction, movement of the adjuster ring in a proximal or distal direction, or a combination thereof results in adjusting the stroke of the actuator without increasing or decreasing tension of the central spring.

18. The actuator of claim 1, wherein movement of the operator shaft is operated by pneumatic or hydraulic pressure acting upon the pressure chamber of the actuator.

19. The actuator of claim 1, wherein the adjustment plate possesses an internal bore and wherein the adjuster plug is positioned substantially within the internal bore of the adjustment plate.

20. The actuator of claim 1, wherein the adjustment plate and the adjuster plug and the adjuster plate are a unitary component.
